(19) United States
(12) Patent Application Publication
(10) Pub. No.: US 2025/0028293 A1
(43) Pub. Date: Jan. 23, 2025

(54) Redundant Automation System and Method for Operation

(71) Applicant: Siemens Aktiengesellschaft, Muenchen (DE)

(72) Inventors: Thomas GROSCH, Roßtal (DE); Albert RENSCHLER, Ettlingen (DE)

(21) Appl. No.: 18/775,258

(22) Filed: Jul. 17, 2024

(30) Foreign Application Priority Data
Jul. 19, 2023 (EP) 23186260

(51) Int. Cl. G05B 19/05

(52) U.S. Cl. CPC G05B 19/058; G05B 2219/24192

(57) ABSTRACT

A redundant automation system includes a first and a second identically configured subsystems, which each have a control program for controlling a technical process, wherein a synchronization connection is between the first and second subsystems, saved in the first subsystem in a source file is status information including static configuration data and dynamic runtime data, in order to enable uninterrupted updates of the second subsystem, a first data reconciliator is configured with a first independent program unit that is configured to incrementally read out write accesses of dynamic runtime data of the first subsystem to the source file to update the dynamic runtime data of the second subsystem and to transfer data contents of repeat write accesses to the second subsystem, and a second data reconciliator is configured with a second independent program unit configured to incrementally receive the repeat write accesses and subsequently storing them in a target file.

### BACKGROUND OF THE INVENTION

### 1. Field of the Invention

The invention relates to a redundant automation system comprising a first and second subsystems, which each have a respective control program for controlling a technical process and are each configured in an identical manner, where a synchronization connection is present between the first subsystem and the second subsystem, status information, which comprises static configuration data and dynamic runtime data, is saved in the first subsystem in a source file, where the first subsystem has a first data reconciliator is configured to reconcile data of the status information of the first subsystem with status information of the second subsystem, and where the second subsystem has a second data reconciliator.

### 2. Description of the Related Art

In the field of automation, there is an increasing demand for high-availability solutions (HA systems), which are suitable for reducing any potentially occurring downtimes of a plant to a minimum. The development of high-availability solutions of this kind is very cost-intensive, where an HA system that is conventionally used in the field of automation is characterized by a plurality of subsystems in the form of automation devices or computer systems being coupled to one another via a synchronization connection. In principle, it is possible for both subsystems to have read and/or write access to the peripheral units connected to the HA system. One of the two subsystems is guiding in relation to the peripheral connected to the system. This means that outputs to peripheral units or output information for the peripheral units are only performed by one of the two subsystems, which operates as master or has assumed the function of master. In order for both subsystems to be able to run in sync, they are synchronized via the synchronization connection at regular intervals. In relation to the frequency of the synchronization and the extent thereof, it is possible to distinguish between various characteristics (warm standby, hot standby).

Moreover, it must also be ensured that, as part of the transfer of the process control from solo or non-redundant operation to redundant operation, such as after replacing a failed subsystem, this transfer or this transition is accomplished in a smooth manner. As part of a transfer of this kind, it is necessary to transfer relevant data from the subsystem that was previously guiding the process to the newly or additionally connected or applied subsystem. As part of this transfer, referred to as coupling and updating, during what is referred to as a coupling and update phase (CaU phase) the technical process to be controlled or the process control is not permitted to be influenced in a disruptive manner; the process control must continue to run without disruption during this CaU phase—referred to as update phase below for the sake of simplicity.

EP 2 667 269 B1 discloses a method for operating a redundant automation system. EP 2 657 797 B1 likewise proposes a method for operating a redundant automation system.

During a coupling and updating procedure, all status-relevant data is transferred from a programmable logic controller (PLC) that is currently still running to the PLC that is to be integrated into the redundant system. This status information also includes persistent data, which is usually saved in files on a file system. This persistent data is modified by the control program on an ongoing basis, for example, when new logging data is to be saved on the file system. Data capture must also occur in an uninterrupted manner, even during the coupling and updating procedure during which the same data has to be modified on an ongoing basis and synchronized with the newly added PLC.

In the conventional methods or devices, the write access to the persistent data is locked during the sync-up procedure and the data is copied to the newly added PLC. Write access is only possible again for the control program once the update procedure has completed.

Accordingly, it is disadvantageous that the status information saved in the first subsystem, in particular current dynamic runtime data, can be lost or has to be temporarily stored in a complex manner.

### SUMMARY OF THE INVENTION

In view of the foregoing, is an object of the present invention to provide a method and redundant automation system that eliminate the foregoing disadvantage.

This and other objects and advantages are achieved in accordance with the invention by a redundant automation system in which a first data reconciliator is configured to transfer static configuration data to a second subsystem, where the second data reconciliator is configured to back up the static configuration data and create a target file for the dynamic runtime data, where the first data reconciliator is configured with a first independent program unit, which in turn is configured to incrementally read out write accesses of dynamic runtime data of the first subsystem to the source file for the updating of the dynamic runtime data of the second subsystem, and for synchronization purposes to transfer the data contents of the repeat write accesses to the second subsystem. Here, the second data reconciliator is embodied with a second independent program unit, which in turn is configured for incrementally receiving the repeat write accesses and subsequently storing them in the target file, where the first subsystem is configured in such a manner, and where the first control program is synchronized with the first independent program unit and the second subsystem is configured such that the second control program is synchronized with the second independent program unit, whereby an order of the write accesses to the source file and the target file is identical on both subsystems.

As soon as the source file on the first subsystem has been fully read and transferred, the content of the source file is identical to the content of the target file, as in the meantime write accesses are likewise performed on both subsystems in a synchronized manner. As of this point in time, the redundant operation is achieved and the independent program unit for data transfer that was activated in the meantime can be terminated again.

The data capture can now occur in an uninterrupted manner, because even during the synchronization phase the data continues to be captured and synchronized on an ongoing basis by the independent program units. Without the independent program units or independently running tasks, the data that previously would have been lost without the invention is gradually embedded into the system again.

Furthermore, the first subsystem assumes guidance of the process and, in the event of a possible fault or a failure of the first subsystem, the second subsystem assumes guidance of the process, furthermore configured such that the failed or faulty first subsystem, after fault correction or a replacement, is updated with status information from the second subsystem that is still running, in order for its control program to once again operate in sync with the control program of the second subsystem, in order to assume guidance of the process should the respective subsystem fail again.

In order to reduce a later time lag, an update phase occurs on a supplementary basis for synchronization purposes. When the process control is transferred from solo or non-redundant operation to redundant operation, for example, after replacing a failed subsystem, this transfer or this transition is to be accomplished in as smooth a manner as possible. As part of a transfer of this kind, it is necessary to transfer relevant data from the subsystem that was previously guiding the process to the newly or additionally connected or applied subsystem. As part of this transfer, referred to as coupling and updating, during what is referred to as a coupling and update phase (CaU phase), the technical process to be controlled or the process control is not permitted to be influenced in a disruptive manner. The process control must continue to run without disruption during this CaU phase—referred to as update phase below for the sake of simplicity.

To this end, the redundant automation system is configured to transfer the process control from solo operation of one of the subsystems to redundant control operation with the other subsystem, where the one subsystem is configured to transmit the second file in fragmented form to the other subsystem as part of an update phase via the synchronization connection and to temporarily save process input values and approvals by the one subsystem, where the approvals show which processing segments of the control program the one subsystem has already processed, in this case the other subsystem is further configured, after receiving the second file, to process approved processing segments of a control program, which correspond to the processing segments of the control program of the one subsystem, while taking into consideration the temporarily stored process input values with a time lag, and where the automation system is configured to process the processing segments of the control program more quickly relative to the processing of the processing segments of the control program in order to reduce the time lag of the processing to a predefined value.

In order to reduce a communication load, the redundant automation system is configured such that the first data reconciliator breaks down the second file into data pieces for the fragmented transfer, where the size of the data pieces is chosen such that it does not have a negative influence on a responsiveness of the first subsystem due to the additional load for the data transfer.

The objects and advantages are also achieved in accordance with the invention by a method for operating a redundant automation system, where a first and second subsystems each process a respective control program in order to control a technical process, where the first subsystem guides the process with a first control program and the second subsystem processes a second control program in sync such that, in the event of a failure of one of the two subsystems, the subsystem that has failed or is faulty in each case, after fault correction or a replacement, is updated with status information from the subsystem that is still running via a data reconciliator, in order to operate in sync with its control program again, in order to assume the guiding of the process in the event of a repeat failure of the respective subsystem, where the status information comprises static configuration data and dynamic runtime data, via the first data reconciliator the static configuration data is transferred to the second subsystem, via the second data reconciliator the static configuration data is backed up and a target file is created for the dynamic runtime data on the second subsystem, the first data reconciliator starts a first independent program unit, which incrementally reads out the write accesses of dynamic runtime data of the first subsystem to the source file for the updating of the dynamic runtime data of the second subsystem, and for synchronization purposes transfers the data contents of said repeat write accesses to the second subsystem, where the second data reconciliator starts a second independent program unit, which incrementally receives the data contents of the repeat write accesses and subsequently stores them in the target file, where the first control program is operated by the first independent program unit in a synchronized manner and where the second control program is operated by the second independent program unit in a synchronized manner, whereby an order of the write accesses to the source file and the target file proceeds in an identical manner on both subsystems.

Conventional methods lock the write access during the sync-up procedure or update procedure. The inventive method allows the control program to also have write access to the persistent data during the sync-up procedure. The advantage lies in the uninterrupted capture of the persistent data, even during the sync-up procedure. The control program therefore does not need to implement any particular behavior for the sync-up procedure (for example, temporarily storing the data), which simplifies the realization of the control program and reduces the testing effort.

In order for parameters (for example, regulating parameters, position values, limit values) to be retained beyond POWER OFF and restarting of a subsystem, these must be backed up in a persistent manner in advance. The parameters can be backed up as remanent data or using the write functionality of a PLC, such as in a CSV file.

In the context of the invention, “persistence” is understood in information technology as the property of a system of keeping the status of its data, its object model and/or its logical connections available over a long time, in particular beyond a planned or unplanned program termination. For this, a non-volatile storage medium is required. The file system or a database as well as a bidirectional and transaction-oriented data transfer backed-up by logs can also be considered a non-volatile medium. As a program can be interrupted at any time in an unexpected manner, persistent data storage in particular means that any status change of the data must be immediately saved on the non-volatile medium.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, its embodiments as well as its advantages are explained in further detail below on the basis of the drawing, which illustrates an exemplary embodiment of the invention, in which:

FIG. 1 shows a sequence of a temporally asynchronous coupling of two subsystems in accordance with the invention;

FIG. 2 shows an update sequence in accordance with the invention;

FIG. 3 shows a redundant automation system in accordance with the prior art;

FIG. 4 shows the redundant automation system with data reconciliator in accordance with the invention;

FIG. 5 shows a sequence of the synchronization with a first and a second file in a first subsystem in accordance with the invention; and

FIG. 6 is a flowchart of the method in accordance with the invention.

### DETAILED DESCRIPTION OF THE EXEMPLARY EMBODIMENTS

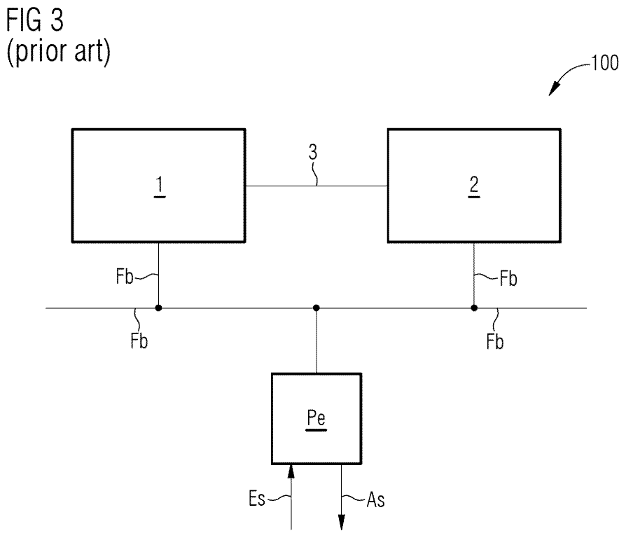

Reference is initially made to FIG. 3 (prior art), which shows a known redundant automation system 100 comprising two subsystems. A first subsystem 1 and a second subsystem 2 are connected to a peripheral unit Pe via a fieldbus Fb. In this case, the fieldbus Fb meets the PROFINET IO specification, for example. In principle, other bus systems are also suitable, for example, Ethernet, Fieldbus, Modbus or other parallel bus systems. The peripheral unit Pe obtains signals from measuring transmitters or measuring transducers, which are used for capturing a process status, via input lines Es and outputs signals to actuators, with which the process is influenced, via output lines As. The process as well as the measuring transmitters, measuring transducers and actuators are not shown in the figure for the sake of clarity. The two subsystems 1,2 process the same control program in a cyclical and synchronous manner. For the synchronization thereof, a synchronization connection 3 is provided, where the redundancy and monitoring functions are implemented via the synchronization connection 3.

As explained, from a point in time at which an update phase is completed, the automation system 100 operates in a redundant operating manner and, with regard to the process control, a subsystem 1,2 is transferred from the solo operation into the redundant operation with a further subsystem. From this point in time, both subsystems 1,2 run through the same program paths with events in sync, for example, due to an event in the form of a process alarm, where the run-through via the first subsystem 1 and the run-through via the second subsystem 2 preferably occurs in an asynchronous manner.

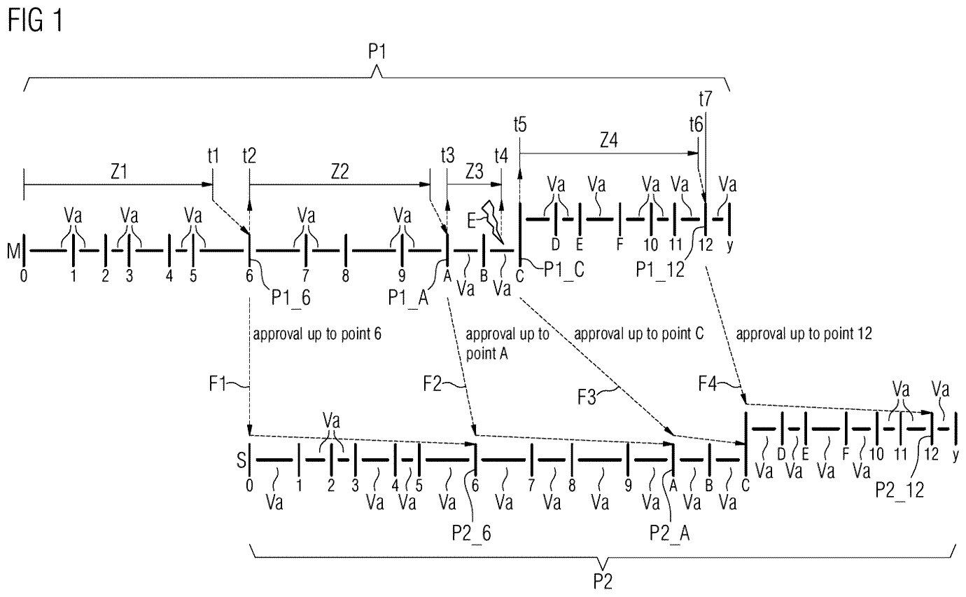

To explain a processing of the control programs P1, P2 with events in sync and for better understanding of the invention, to this end reference is made below to FIG. 1, which shows a proposed sequence of a temporally asynchronous coupling of the two subsystems 1,2. In this context, “processing with events in sync” means that both the master and the slave run through the same program paths of the respective control program due to an event, where the run-throughs occurs in a temporally asynchronous manner.

It is assumed that one of the subsystems 1,2 is operated as master M and one of the subsystems 1,2 is operated as slave S or reserve. The master M is therefore guiding with regard to the control of a technical process, and assumes the process control, where the master M reads the process input information or process input values from the peripheral unit Pe (FIG. 3) and provides these to the slave S in a temporally asynchronous manner. The slave S then assumes the master function or master role, if the master M fails due to disruption.

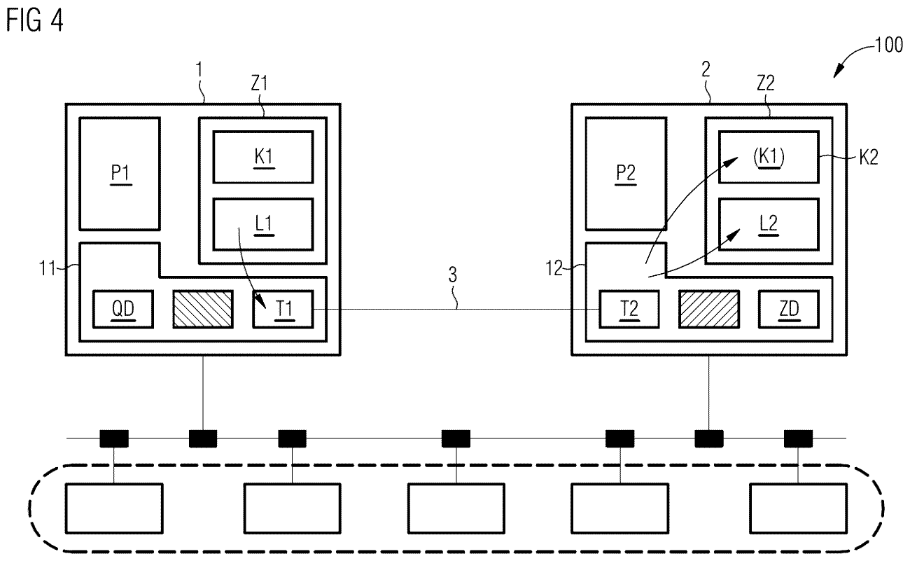

The master M processes a program P1 for controlling the technical process, where the slave S also processes a second control program P2 that corresponds to this first control program P1. Both control programs P1, P2 have a plurality of processing sections Va of different duration, where the control programs P1, P2 can be interrupted at the respective beginning and the respective end of each processing section Va. Beginning and end of each processing segment Va, which conventionally comprises a large number of program codes, thus represent interruptible program or interruption points 0, 1, 2, . . . y. At these interruption points 0, 1, 2, . . . y, the respective control program P1, P2 can be interrupted if necessary via the master M and the slave S, in order to be able to initiate suitable responses after the occurrence of an event or a process alarm. Furthermore, at these interruption points 0, 1, 2, . . . y, the respective control program P1, P2 can be interrupted, so that the master M and the slave S can exchange approvals, acknowledgements or other information via the fieldbus Fb or via the synchronization connection Sv (FIG. 4). After a respective predeterminable or predetermined time interval Zi, i=1, 2, . . . has elapsed and at the respective point in time of the occurrence of an interruption point that follows after the respective time interval Zi has elapsed (preferably the first interruption point that follows the respective time interval Zi), the master M transmits to the slave S an approval or an approval signal, which indicates to the slave S the processing segment Va up to which the slave S is permitted to process the control program P2. These processing segments Va of the control program P2 correspond to those that the master M has already processed during the processing of the control program P1.

In the present exemplary embodiment, it is assumed that after a time interval Z1 has elapsed, at a point in time t1 and at a point in time t2, at which a first interruption point P1_6 (interruption point 6) follows the time interval Z1, the master M transmits an approval F1 to the slave S. This approval F1 comprises the information for the slave S that the slave is permitted to process its control program P2 to be processed up to an interruption point P2_6 (interruption point 6), where the interruption point P2_6 of the control program P2 corresponds to the interruption point P1_6 of the control program P1. This means that, due to the approval, the slave S can process the processing segments Va of the control program P2 that correspond to the processing segments Va of the control program P1 up to the point in time of the generation of the approval or of the approval signal, where in the example it is assumed for the sake of simplicity that the point in time of the generation of the approval corresponds to the point in time of the transmitting of the approval to the slave S. The processing of these processing steps Va via the slave S thus occurs temporally asynchronously to the processing of the corresponding processing segments Va via the master M, where after the processing of the processing segments Va of the control program P2 by the slave S, a processing of further processing segments Va by the slave S only occurs when the master M transmits a further approval to the slave S.

The point in time of the occurrence of this interruption point P1_6, P2_6 (interruption point 6) represents the beginning of a time interval Z2 that follows the time interval Z1.

The further temporally asynchronous processing of the control programs P1, P2 occurs in the manner described. At a point in time t3 of the occurrence of a first interruption point P1_A after the time interval Z2 has elapsed, the master M transmits a further approval F2 to the slave S, which indicates to the slave S that it can process these further processing segments Va up to the interruption point P2_A. These processing segments Va in turn correspond to those that the master M has already processed from the point in time t2 to point in time t3, i.e., up to interruption point P1_A. This means that the slave S processes the processing segments Va from the point in time t2 of the previous approval F1 to the point in time t3 of the current approval F2. The point in time t3, at which the first interruption point P1_A has occurred after the time interval Z2 has elapsed, is the beginning of a time interval Z3 that follows the time interval Z2.

It can now occur that an event, for example, an event in the form of a process alarm, occurs during a time interval. In the exemplary embodiment, such an event is designated by E, to which the master M must react suitably during the time interval Z3 at a point in time t4 in accordance with the control program P1. Here, the master M transfers an approval F3 to the slave S not at a point in time of the occurrence of an interruption point that follows the time interval Z3 after the time interval Z3, but at a point in time t5 of the occurrence of an interruption point P1_C (interruption point C) that follows the occurrence of the event E. This means that the time interval Z3 is shortened due to the event E, where the point in time t5 is the beginning of a following time interval Z4. Due to the approval F3 transmitted to the slave S, the slave S processes the processing segments Va of the control program P2 that correspond to the processing segments Va of the first control program P1 that the master M has already processed between the points in time t3 and t5.

Due to the event E, the master M processes processing segments Va of higher priority during the time interval Z4, for example, the master M undertakes a change of thread at point in time t5, and in turn, after the time interval Z4 has elapsed, at point in time t6 transmits an approval F4 at a point in time t7, at which a first interruption point P1_12 (interruption point 12) that follows the time interval Z4 occurs. Due to this approval, the slave S likewise processes processing segments Va up to an interruption point P2_12 (interruption point 12) of the control program P2, where these processing segments Va correspond to the processing segments Va of the control program P1 between the points in time t5 and t7 and where the slave S likewise undertakes a change of thread.

As explained, the approvals of the master M enable the slave S to run through the same “thread stack” as the master M, which means that the slave S undertakes a “change of thread” at a point in the control program P2 that corresponds to the point in the control program P1. The slave S only continues its processing when it is requested to do so by the master M by way of an approval. With regard to the processing of the processing segments, the master M processes these in real time in the manner of a standalone operation or in the manner of a non-redundant operation and at regular intervals and also, after the occurrence of events, issues approvals for processing corresponding processing segments via the slave S, where the master M continues to process the first control program P1 and does not actively wait for a response of the slave S. The slave S runs behind the master M in relation to the processing of the corresponding processing segments and processes said segments due to the master approvals issued.

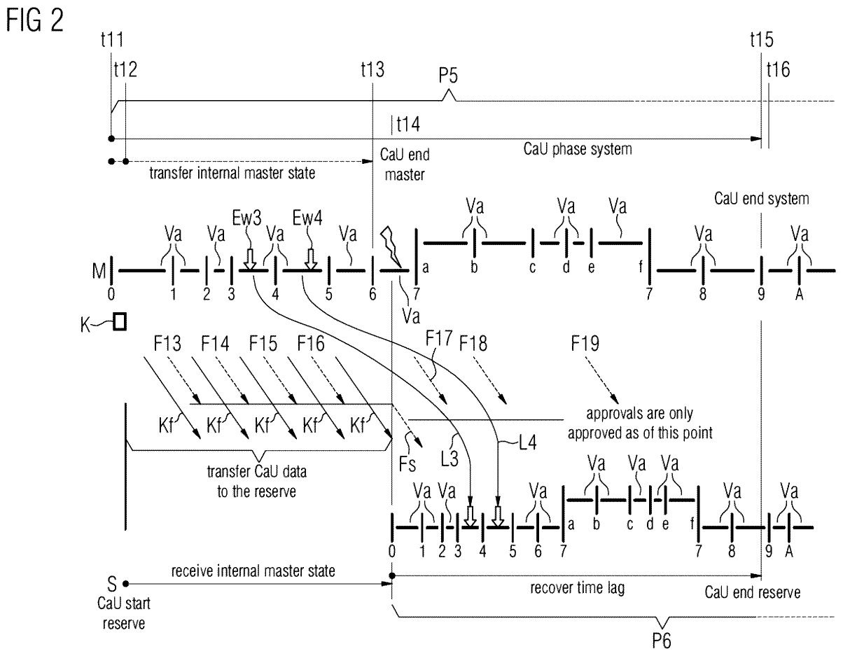

In the following, it is assumed that the process control is to be transferred from solo operation of the master M to redundant control operation with the slave S. A transfer of this kind is necessary, for example, if the slave S is coupled to the master M again after a repair. To this end, reference is made to FIG. 2, which shows an update sequence of the automation system 100.

This transfer beings at a point in time t11, by which the master M has identified that the slave S is coupled to the fieldbus Fb (FIG. 3), where the update phase of both the master M and the slave S begins from this point in time t11. From this point in time t11, the master M creates a local copy K of all relevant data, which represents its internal status up to this point in time t11, where the master M continues to control the technical process in solo operation and processes processing segments Va of a control program P5. From a point in time t12 to a point in time t13, at which the update phase of the master M is completed, the master M transmits this copy K to the slave S in fragmented form, which is indicated in the drawing by means of arrows Kf, which the slave S has fully received up to a point in time t14. At this point in time t14, the slave S now has the same internal status as the master at the point in time t11. From the point in time t12, furthermore all approvals of the master M as well as all process input values read-in by the master M from the peripheral unit Pe (FIG. 3) are temporarily stored on the master M, the slave S or a further subsystem of the automation system, where the approvals are only approved for processing by the slave S after the copy K has been fully received. In the present exemplary embodiment, it is assumed that during a time segment from the point in time t11 to the point in time t13, at which the transfer of the copy K is completed, the master M running in solo operation has generated approvals F13, F14, F15, F16 and has further read in process input values Ew3, Ew4. These approvals F13 to F16 and these process input values Ew3, Ew4 are approved for the slave S only from a point in time t14, i.e., at the point in time at which the internal status of the master M is fully provided to the slave S, which is indicated in the figure by an arrow Fs and by curved lines L3, L4. After this approval by the master M, the slave S brings itself to the internal status of the master M, in that the slave S processes the data of the copy K in accordance with the approvals F13 to F16. Here, the slave S processes the processing segments Va of its control program P6, which correspond to the processing segments Va of the control program P5 of the master M up to point in time t13, where the slave S takes into consideration the process input values Ew3, Ew4 with regard to the processing of the control program P6.

Due to the slave S bringing itself to the internal status of the master M in a temporally asynchronous manner, with regard to the processing of the corresponding processing segments Va of the control program P6, the slave S runs behind the master M, where this time lag must be reduced to a tolerable level, since a time lag that is too high can lead to a loss of redundancy. In order to reduce this time lag, there is provision for the processing speed of the slave S to be higher relative to the processing speed of the master M, which is shown in the figure in the form of processing segments Va in the control program P6 that are shown in a “shortened” manner. This relative increase in the processing speed of the slave S can be brought about, for example, by the slave S processing the processing segments Va of its program P6 more quickly or the master M processing the processing segments Va of its program P5 more slowly. Only when the time lag is recovered or reduced to a tolerable level or a predefined value is the update phase of the slave S beginning at point in time t12 and thus of the automation system 100 completed.

In the present exemplary embodiment, it is assumed that the time lag has been reduced to a tolerable level at a point in time t15. This level is chosen or predefined such that, in the event of a failure of the master M, the slave can assume the master role in a smooth manner. In the figure, the temporal difference between a point in time t16 and the point in time t15 represents the tolerable level, which in a practical exemplary embodiment of the invention lies in the millisecond range. As part of the update phase of the slave S, the slave S, from the point in time t14 to point in time t15, processes both the approvals F13 to F16 temporarily stored during the transfer of the copy K and also approvals F17, F18, F19 that the master M transmits to the slave S after this transfer. These approvals F17 to F19 indicate to the slave S which processing segments Va of the control program P6 are further to be processed by the slave S, where these processing segments Va correspond to the processing segments Va of the control program P5 that the master M has already processed from point in time t14. In other words, once the master M has fully transmitted the copy K to the slave S or the slave S has fully received this copy K, the slave S, from point in time t14 to point in time t16, processes all approved processing segments Va of its control program P6 that correspond to those that the master M has already processed from point in time t11 to point in time t15.

From point in time t15, the update phase is completed and the automation system 100 is transferred into redundant operation. The process control has changed from solo operation of the master M to redundant operation with the slave S, where the further run-throughs of the corresponding program paths can occur on the master M and the slave S from the point in time t16 temporally asynchronously in the manner described or temporally in sync in a per se known manner.

FIG. 4 shows the previously described automation system 100 with the expansion of the data reconciliator 11,12. Here, the first subsystem 1 has a first data reconciliator 11 and the second subsystem 2 has a second data reconciliator 12. The first subsystem 1 has the first control program P1 for controlling the technical process, and the second subsystem 2 has the second control program P2, likewise for controlling the technical process. In order to synchronize the first subsystem 1 with the second subsystem 2, the synchronization connection 3 is provided. Saved in the first subsystem 1 is status information Z1, which comprises static configuration data K1 and dynamic runtime data L1. The first subsystem 1 with its first data reconciliator 11 is configured to reconcile data of the status information Z1 of the first subsystem 1 with status information Z2 of the second subsystem 2, where the second subsystem 2 has the second data reconciliator 12.

The first data reconciliator 11 is configured to transfer the static configuration data K1 to the second subsystem 2, the second data reconciliator 12 is configured to back up the static configuration data K1 and create a target file ZD for the dynamic runtime data L1, the first data reconciliator 11 is furthermore configured with a first independent program unit T1, which in turn is embodied to incrementally read out write accesses of dynamic runtime data L1 of the first subsystem 1, which can also occur during the update phase, to the source file QD for the updating of the dynamic runtime data L2 of the second subsystem 2, and for synchronization purposes to transfer the data contents of said repeat write accesses to the second subsystem 1. The independent program unit T1 could be configured as a task or as a synchronized transfer thread.

The second data reconciliator 12 is configured with a second independent program unit T2, which in turn is configured for incrementally receiving the repeat write accesses and subsequently storing them in the target file (ZD). The second independent program unit T2 could also be configured as a task or as a synchronized transfer thread.

In order to ensure the synchronization, the first subsystem 1 is configured such that the first control program P1 is synchronized with the first independent program unit T1 and the second subsystem 2 is configured such that the second control program P2 is synchronized with the second independent program unit T2, whereby an order of the write accesses to the source file QD and the target file ZD is identical on both subsystems.

In order to achieve this, via the first data reconciliator 11, the static configuration data K1 is transferred to the second subsystem 2, via the second data reconciliator 12 the static configuration data (K1) is backed up and a target file (ZD) is created for the dynamic runtime data L1 on the second subsystem 2.

The first data reconciliator 11 then starts the first independent program unit T1, which incrementally reads out the write accesses of dynamic runtime data L1 of the first subsystem to the source file QD for the updating of the dynamic runtime data L2 of the second subsystem 2, and for synchronization purposes transfers the data contents of the repeat write accesses to the second subsystem 2. The second data reconciliator 12 then starts the second independent program unit T2, which then incrementally receives the data contents of the repeat write accesses and subsequently stores them in the target file (ZD).

The first subsystem 1 and the second subsystem 2 are configured such that the first control program P1 is operated by the first independent program unit T1 in a synchronized manner and the second control program P2 is operated by the second independent program unit T2 in a synchronized manner, whereby an order of the write accesses to the source file QD and the target file ZD proceeds in an identical manner on both subsystems 1,2.

As soon as the source file QD on the first subsystem 1 has been fully read and transferred, the content of the source file QD is considered identical to the content of the target file ZD, because in the meantime the write accesses have likewise been performed on both subsystems 1,2 in a synchronized manner. As of this point in time, the redundant operation is achieved and the independent program units T1, T2 for data transfer that were activated in the meantime can be terminated again.

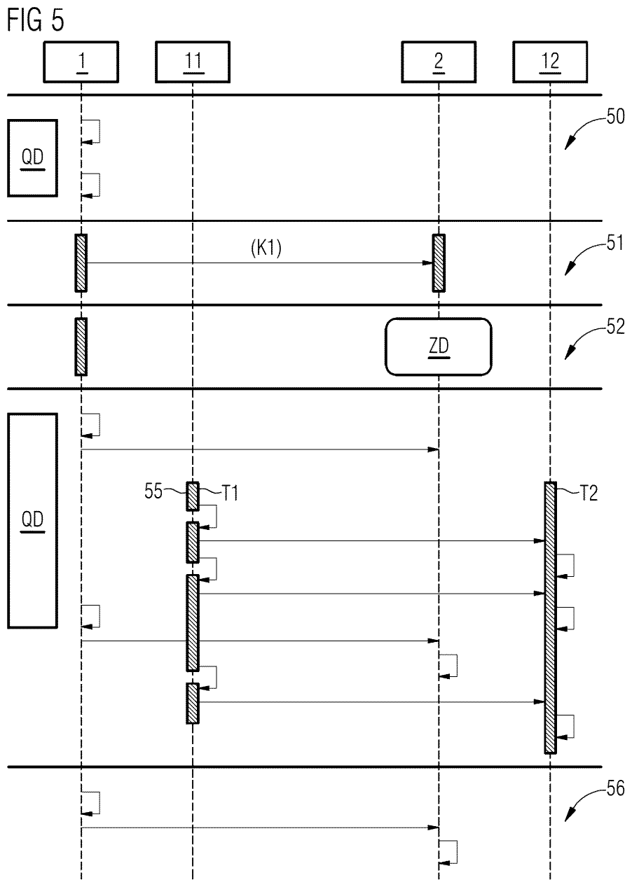

With reference to FIG. 5, shown therein is the sequence in accordance with the method for “updating” or synchronizing from the first subsystem 1 to the second subsystem 2. The first subsystem 1 first runs in solo operation 50. The write and read accesses for the dynamic runtime data L1 are implemented on the source file QD in the first subsystem 1. The first static configuration data K1 is transferred in the step Start Synchro 51. In step 52, a memory map is created and the target file ZD is created on the second subsystem. This starts the data transfer 55 or the first independent program unit T1. With step 56, the redundant operation is achieved again.

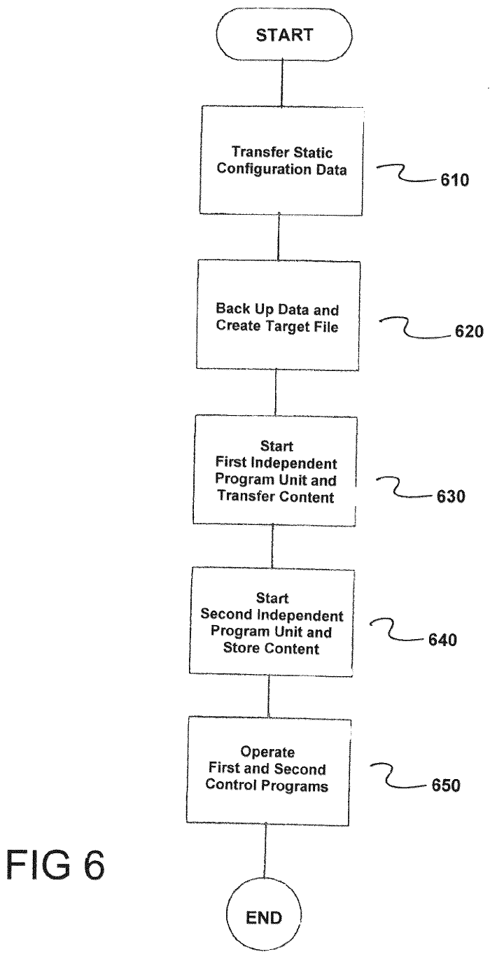

FIG. 6 is a flowchart of the method for operating a redundant automation system, where a first subsystem 1 and a second subsystem 2 for controlling a technical process each process a respective control program P1,P2, the first subsystem 1 guides the process with a first control program P1 and the second subsystem 2 processes a second control program P2 in sync such that, in an event of a failure of one subsystem of the first and second subsystems 1,2. In addition, a subsystem 1,2 that has failed or is faulty, after fault correction or a replacement, is updated with status information Z1,Z2 from another subsystem of the first and second subsystems 1,2 that is still running via a data reconciliator 11,12, in order to again operate in sync with a respective control program P1,P2, in order to assume the guidance of the process in an event of a repeat failure of a respective subsystem of the first and second subsystems 1,2, where the status information Z1,Z2 comprises static configuration data K1,K2 and dynamic runtime data L1,L2.

The method comprises transferring, via a first data reconciliator 11, the static configuration data K1 to the second subsystem 2 as indicated in step 610.

Next, a second data reconciliator 12 backs up the static configuration data K1 and a target file ZD for the dynamic runtime data L1 on the second subsystem 2 is created, as indicated in step 620.

Next, the first data reconciliator 11 starts a first independent program unit T1 that incrementally reads out write accesses of dynamic runtime data L1 of the first subsystem to a source file QD for update of the dynamic runtime data L2 of the second subsystem 2, and the data contents of repeat write accesses are transferred to the second subsystem 1 for synchronization purposes, as indicated in step 630.

Next, the second data reconciliator 12 starts a second independent program unit T2 that incrementally receives data contents of the repeat write accesses and subsequently stores the received data contents of the repeat write accesses in the target file ZD, as indicated in step 640.

Next, the first independent program unit T1 operates the first control program P1 in a synchronized manner and the second independent program unit T2 operates the second control program in a synchronized manner, such that an order of the write accesses to the source file QD and the target file ZD proceeds in an identical manner on the first and second subsystems 1,2, as indicated in step 650.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A redundant automation system comprising:
a first subsystem;
a second subsystem, the first and second subsystems each having a control program for controlling a technical process and being configured in an identical manner;
a synchronization connection operatively coupled between the first subsystem and the second subsystem; and
status information comprising static configuration data and dynamic runtime data saved in the first subsystem in a source file;
wherein the first subsystem includes a first data reconciliator configured to reconcile data of the status information saved in the first subsystem with status information of the second subsystem which includes a second data reconciliator;
wherein the first data reconciliator is further configured to transfer the static configuration data to the second subsystem;
wherein the second data reconciliator is configured to back up the static configuration data and create a target file for the dynamic runtime data;
wherein the first data reconciliator is configured with a first independent program unit which is configured to incrementally read out write accesses of dynamic runtime data of the first subsystem to the source file for the updating of the dynamic runtime data of the second subsystem, and to transfer data contents of said repeat write accesses to the second subsystem for synchronization purposes;
wherein the second data reconciliator is configured with a second independent program unit which is configured to incrementally receive the repeat write accesses and subsequently store said repeat write accesses them in the created target file;
wherein the first subsystem is further repeat write accesses in such that the first control program is synchronized with the first independent program unit; and
wherein the second subsystem is configured such that the second control program is synchronized with the second independent program unit;
whereby an order of the write accesses to the source file and the target file is identical on the first and second subsystems.

2. The redundant automation system as claimed in claim 1, wherein redundant automation system is configured such that the first subsystem is further configured to guide the process and, in an event of a possible fault or a failure of the first subsystem, the second subsystem assumes guidance of the process; and
wherein the redundant automation system is further configured such that failed or faulty first subsystem, after fault correction or a replacement, is updated with status information from the second subsystem which is still running, in order for the control program of the first subsystem to once again operate in sync with the control program of the second subsystem to assume the guidance of the process should a respective subsystem of the first and second subsystems fail again.

3. The redundant automation system as claimed in claim 1, wherein the redundant automation system is configured to transfer the process control from solo operation of one subsystem of the first and second subsystems to redundant control operation with another subsystem of the first and second subsystems;
wherein the one subsystem is configured to transmit contents of the source file in fragmented form to the other subsystem as part of an update phase via the synchronization connection and to temporarily save process input values and approvals by the one subsystem;
wherein the approvals show which processing segments of the control program has already processed been proceeded by the one subsystem, in this case the other subsystem being further configured, after receiving the contents of the source file, to process approved processing segments of the control program of the other subsystem, which correspond to the processing segments of the control program of the one subsystem, while taking into consideration the temporarily saved process input values with a time lag; and
wherein the redundant automation system is further configured to process the processing segments of the control program of the other subsystem more quickly relative to the processing of the processing segments of the control program to reduce processing time lag to a predefined value.

4. The redundant automation system (100) as claimed in claim 2, wherein the redundant automation system is configured to transfer the process control from solo operation of one subsystem of the first and second subsystems to redundant control operation with another subsystem of the first and second subsystems;
wherein the one subsystem is configured to transmit contents of the source file in fragmented form to the other subsystem as part of an update phase via the synchronization connection and to temporarily save process input values and approvals by the one subsystem;
wherein the approvals show which processing segments of the control program has already processed been proceeded by the one subsystem, in this case the other subsystem being further configured, after receiving the contents of the source file, to process approved processing segments of the control program of the other subsystem, which correspond to the processing segments of the control program of the one subsystem, while taking into consideration the temporarily saved process input values with a time lag; and
wherein the redundant automation system is further configured to process the processing segments of the control program of the other subsystem more quickly relative to the processing of the processing segments of the control program to reduce processing time lag to a predefined value.

5. The redundant automation system (100) as claimed in claim 3, wherein the first data reconciliator (11) breaks down contents of the source file (QD) into data pieces for the fragmented transfer; and wherein a size of said data pieces is chosen so as to not have a negative influence on a responsiveness of the first subsystem (1) due to an additional load for the data transfer.

6. A method for operating a redundant automation system, a first subsystem and a second subsystem for controlling a technical process each processing a respective control program, the first subsystem guiding the process with a first control program and the second subsystem processing a second control program in sync such that, in an event of a failure of one subsystem of the first and second subsystems (1,2), a subsystem which has failed or is faulty, after fault correction or a replacement, being updated with status information from another subsystem of the first and second subsystems which is still running via a data reconciliator, in order to again operate in sync with a respective control program, in order to assume the guidance of the process in an event of a repeat failure of a respective subsystem of the first and second subsystems, and the status information comprising static configuration data and dynamic runtime data, the method comprising:
transferring, via a first data reconciliator, the static configuration data to the second subsystem;
backing up, via a second data reconciliator, the static configuration data and creating a target file for the dynamic runtime data on the second subsystem;
starting, by the first data reconciliator, a first independent program unit which incrementally reads out write accesses of dynamic runtime data of the first subsystem to a source file for update of the dynamic runtime data of the second subsystem, and transferring the data contents of repeat write accesses to the second subsystem for synchronization purposes;
starting, by the second data reconciliator, a second independent program unit which incrementally receives data contents of the repeat write accesses and subsequently storing said received data contents of the repeat write accesses in the target file;
operating, by the first independent program unit, the first control program in a synchronized manner and operating, by the second independent program unit, the second control program is operated in a synchronized manner, such that an order of the write accesses to the source file and the target file proceeds in an identical manner on the first and second subsystems.

7. The method as claimed in claim 6, wherein as soon as the source file on the first subsystem has been fully read and transferred, the content of the source file is considered identical to the content of the target file, because in the meantime the write accesses have likewise been performed on both subsystems in a synchronized manner, as of this point in time, the redundant operation being achieved and the independent program units for data transfer that were activated in the meantime being again terminatable.
